(19) United States
(12) Patent Application Publication
(10) Pub. No.: US 2010/0206192 A1
(43) Pub. Date: Aug. 19, 2010

(54) Web Printing Press with Complete Machine Setups

(75) Inventors: Michael Raymond Rancourt, Merrimack, NH (US); Howard Hoff, Lee, NH (US)

Correspondence Address: Davidson, Davidson & Kappel, LLC, 485 7th Avenue, 14th Floor, New York, NY, 10018, US

(73) Assignee: GOSS INTERNATIONAL AMERICAS, INC., Durham, NH (US)

(21) Appl. No.: 12/388,151

(22) Filed: Feb. 18, 2009

(51) Int. Cl. B41F 5/04

(52) U.S. Cl. 101/219

(57) ABSTRACT

A web fed rotary printing press apparatus and a method for operating the same which includes at least one reconfigurable printing mechanism, a sensor for detecting the end of a print job, and a controller coupled to the sensor and the at least one printing mechanism for providing control signals representing predetermined printing parameters for a subsequent print job to the at least one print mechanism upon detection of the end of a print job. The apparatus may further include a planning computer coupled to the controller for generating printing parameters for each print job based on user input. Furthermore, the printing parameters generated by the planning computer for a print job may be stored as data in JDF files communicated to the controller which may be used to provide control signals representing predetermined printing parameters for a print job based on the data in the JDF files.

The present invention relates generally to web printing presses and more particularly to a system for providing web printing press management.

### BACKGROUND

In certain printing operations, a web is fed from a roll mounted in a splicer to a sequence of printing equipment, which may include a number of different print mechanisms such as an infeed unit, a plurality of printing units, a dryer, a cooling unit, a folder superstructure and a delivery unit. The output of the delivery unit may be a plurality of signatures, formed from folded ribbons, the web being slit into ribbons, each signature having a printed image. The individual signatures may be assembled with other printed signatures to form a final product, such as a newspaper.

Some printing presses are manually reconfigured for different print jobs by way of discrete individual adjustments between different print jobs when the printing press is not in operation. This method of reconfiguration increases the risk of human error and contributes to inefficiency, considerable production down-time and waste of valuable run-time.

### SUMMARY OF THE INVENTION

It is an object of the invention to provide a printing press which is automatically reconfigured and thus overcomes the problems associated with manual reconfiguration.

The present invention is addressed to a method for automatically controlling a printing press including at least one reconfigurable printing mechanism. At least one reconfigurable printing mechanism is configured to print according to a first set of predetermined printing parameters for a first print job and then the first print job is printed on a first print web. The completion of the first print job detected, at least one reconfigurable printing mechanism is automatically configured to print according to a second set of predetermined printing parameters different from the first set of predetermined printing parameters for a second print job, and the second print job is printed on a second print web. The first print web may be the same size as the second print web, or the first print web may a different size as the second print web.

The present invention is also addressed to a web fed rotary printing press apparatus which comprises at least one printing mechanism which is reconfigurable based on received control signals, a sensor for detecting the end of a print job, and a controller coupled to the sensor and at least one printing mechanism and which provides control signals representing predetermined printing parameters for a subsequent print job to the at least one print mechanism upon detection of the end of a print job. The apparatus may further include a planning computer coupled to the controller for generating printing parameters for each print job based on user input. Furthermore, the printing parameters generated by the planning computer for a print job may be stored as data in JDF files communicated to the controller which may be used to provide control signals representing predetermined printing parameters for a print job based on the data in the JDF files.

In an alternative embodiment, the planning computer functions are included in the controller which also generates printing parameters for each print job based on user input. In this alternative embodiment, the printing parameters generated by the controller may also be stored as data in JDF files and the control signals provided by the controller representing predetermined printing parameters for a print job may be based on the data in the JDF files.

In an embodiment of the invention, at least one of the printing mechanisms is a slitter which can be automatically reconfigured to slit the web at different positions, and the slitter is automatically configured by laterally moving at least one slitter blade in the slitter. Separate actuators may be provided which are associated with each slitter blade for moving the slitter blades laterally. Sensors may be provided which detect the completion of the first print job by sensing predetermined register marks on the first print web or by the job count, for example, good product delivered. The slitter may be moved to a new slit position with the web in motion. The ribbon path to the former would have to remain the same.

### BRIEF DESCRIPTION OF THE DRAWINGS

The above and related objects, features and advantages of the present invention will be more fully understood by reference to the following detailed description of the presently preferred, albeit illustrative, embodiments of the present invention when taken in conjunction with the accompanying drawings wherein:

FIG. 1 schematically shows an exemplary embodiment of a printing press which can be automatically reconfigured from a current print job to a next print job;

FIG. 2 schematically shows an example of an automatic slitter adjustment for a print job transfer from a wider web to a narrower web; and

FIG. 3 schematically shows an example of an automatic slitter adjustment for a print job transfer from a narrower web to a wider web.

### DETAILED DESCRIPTION OF THE PREFERRED EMBODIMENTS

The Job Definition Format (JDF) is an industry specification for exchanging product specifications using an Extensible Markup Language (XML)-based file format. JDF files are often used in the printing industry to simplify data exchange between different applications and systems. JDF files allow data communication between a printing press and its management system as well as provide access to print job data and printing press configuration data such as, for example, paper, coverage requirements, colors (inks), web width, ribbon width, web path, ribbon path, product fold, skip/tab slitter requirements and former board position. JDF files are created and sent to the printing press by print planning systems.

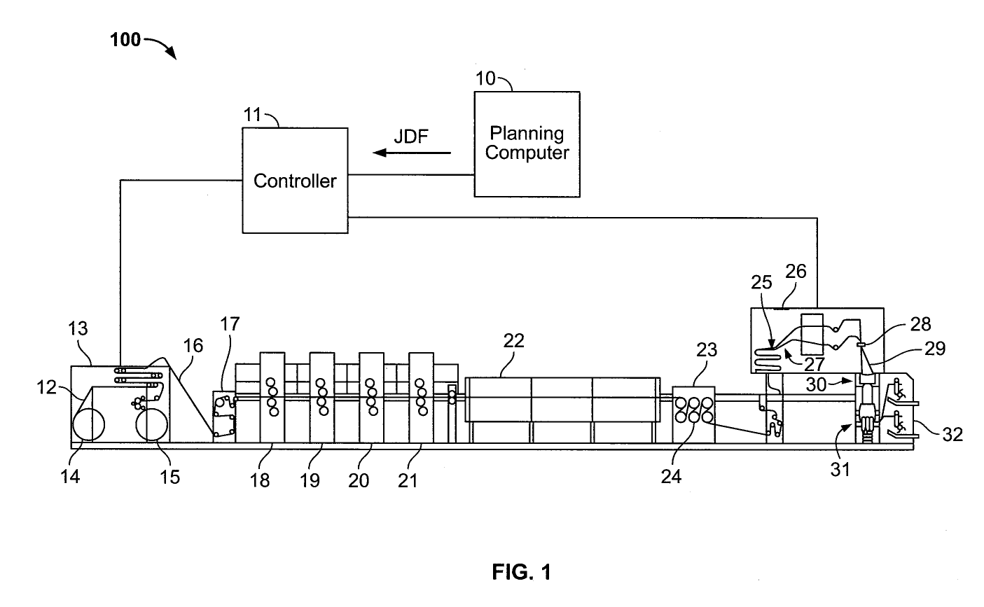

FIG. 1 schematically shows an exemplary embodiment of a printing press 100, which can be automatically reconfigured from a current print job to a next print job. Printing press 100 includes a splicer 13, an infeed unit 17, print units 18 to 21, a dryer 22, a cooling unit 23, a folder superstructure 26 and a delivery unit 32. Printing press 100 also includes a planning computer 10 and a controller 11.

Splicer 13 mounts and splices a roll 14 of a new web 12 onto an end of a web 16, which is fed from a mounted roll 15. Rolls 14, 15 may be of any diameter and any width. New web 12 is used in the next print job and web 16 is used in the current print job. In order to attach new web 12 to the depleting, almost used-up, web 16, an adhesive patch may be applied, via splicer 13, to join the two webs.

Upon exiting splicer 13, web 16 travels to infeed unit 17. Infeed unit 17 feeds web 16 to a sequence of printing units 18, 19, 20, 21. The number of printing units is shown in the exemplary embodiment as four, but could be higher or lower, depending on the different job requirements for printing press 100.

Web 16 then travels, in the exemplary embodiment, through dryer 22, which is positioned downstream from printing units 18, 19, 20, 21. Dryer 22 is used to apply heat to the passing web 16 to dry the ink applied by printing units 18, 19, 20, 21. After passing through dryer 22, web 16 is fed to cooling unit 23, for passage between water cooled rollers 24 before entry into folder superstructure 26.

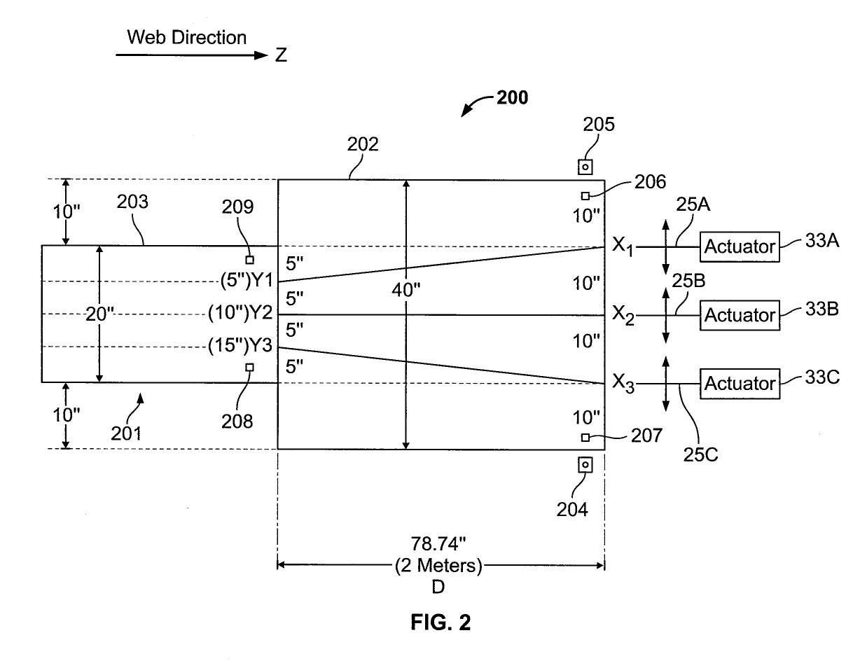

In folder superstructure 26, web 16 is longitudinally slit into a plurality of ribbons 27 by slitters 25, which are movable via operably connected actuators 33 (see FIG. 2). The direction at which web 16 is moving and at which slitters 25 slit web 16 is identical. Slitters 25 can longitudinally slit web 16 via any of known slitting methods, for example, a knife-cut, a shear-cut or a burst-cut.

After slitting, ribbons 27 are guided to a roller top of former 28, which is mounted at the infeed of a former board 29. Once ribbons 27 pass over roller top of former 28, ribbons 27 are drawn over former board 29 by infeed rollers 30, which, if driven, may be used to maintain precise web tension in order to minimize web tearing. Former board 29 imparts a longitudinal fold to ribbons 27 as ribbons 27 pass over former board 29. The newly folded ribbons 27 are then cut by a crosscutter 31 into individual signatures and are guided for input to delivery unit 32.

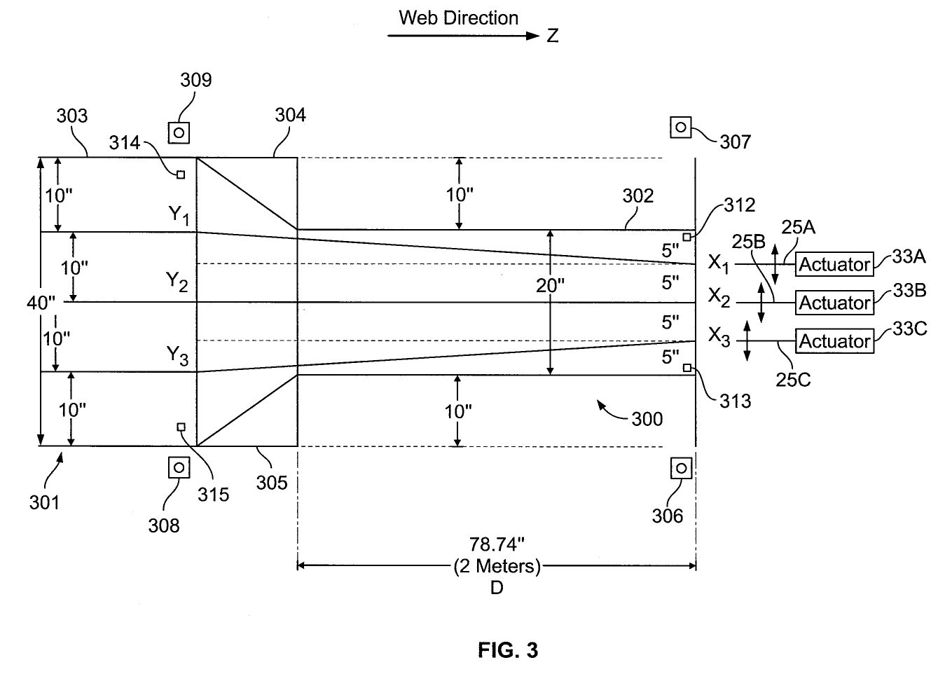

Planning computer 10 is in digital signal communication with controller 11. Planning computer 10 is used to create and send JDF files to controller 11. Planning computer 10 and controller 11 may, alternatively, be embodied in a single unit. Controller 11 may be, for example, a computer or circuitry, such as an application-specific integrated circuit (ASIC). Controller 11 is also JDF data compatible. Controller 11 is programmed to receive and monitor, as inputs, the outputs of various sensors as discussed below with respect to FIGS. 2 and 3. Controller 11 provides signals to control splicer 13 and folder superstructure 26, and may be configured to control the entire printing press 100, which includes various components digitally interconnected via an internal network.

In one mode of operation, where one roll of web corresponds to a single print job, controller 11, continuously monitors web consumption. Upon detecting the impending depletion of web 16 rolled onto mounted roll 15, controller 11 decreases the speed at which web 16 passes through printing press 100 to a certain setup speed. Then, using sensor data and JDF files, controller 11 determines the amount of web 16 left on mounted roll 15 for the current print job in order to successfully activate web splicer 13 and issues a command to splice the web feed from the depleting mounted roll 15 to the unused roll 14 and adjust the circumferential speed of the newly mounted roll 14 to the printing speed. A conventional tail-cutter may be used to remove the loose end of the new roll 14. Subsequently, using sensor data and JDF files, controller 11 tracks the splicing location of new web 12 to web 16 as new web 12 travels through printing press 100 and timely adjusts the positions of slitters 25 and former board 29 as well as maintain proper web tension via infeed rollers 31 for the new print job.

In an alternative mode of operation, more than one roll of web may correspond to a single print job. In such a mode of operation, upon detecting the impending depletion of the last roll allocated for and used in the currently running print job, controller 11 will proceed in a similar mode of operation as where one roll corresponds to one print job and treat the last roll as web 16.

A plurality of various operation data sensors are included in printing press 100. The sensors are used to sense, monitor and output quality control data for the web that moves through printing press 100. The sensors may include, for example, densitometers, color spectrometers, registration sensors, cut-off sensors and fold sensors. The sensors are strategically positioned throughout printing press 100 and configured to sense, monitor and output operating and product quality control parameters such as, for example, printing press speed, printing press operating events, product image density, ink presets, web tension, register marks, ribbon positions, product fold, former board and slitter positions. The sensors are in digital signal communication with controller 11 or planning computer 10 or both.

Printing press 100 is automatically reconfigured for the next print job if no ribbon path changes take place and if at least two print job configurations are known: a current print job configuration and a next print job configuration. This data is included in two corresponding JDF files: e.g., a first file that corresponds to the current print job and a second file that corresponds to the next print job. The ribbon path data is known to printing press 100 via JDF data. In addition, it is desirable that JDF2 file is available to controller 11 prior to the conclusion of the current print job.

For example, printing press 100 is configured for a presently running print job via a JDF file, e.g., JDF1. When the next print job requires a different printing press configuration, prior to the conclusion of the current print job, a printing press operator utilizes planning computer 10 to create and transmit the JDF2 file for the next print job to controller 11 for processing. Controller 11 processes the JDF2 file and the sensor data and, without stopping printing press 100, automatically reconfigures printing press 100 from the current print job configuration to the next print job configuration. Such reconfiguration may include one or more of the following steps: detecting the impending depletion of web feed from mounted roll 15, slowing printing press 100 to a certain set up speed, activating splicer 13 to splice web 16 from mounted roll 15 to web 12 from roll 14, adjusting the lateral positions of slitters 25 via slitter actuators 33 (see FIG. 2), changing the position of former board 29 (fold position) and, if necessary, adjusting the web tension via infeed rollers 30.

FIG. 2 schematically shows an example of an automatic slitter adjustment for a print job transfer from a wide web 200 to a narrow web 201. Wide web 200 corresponds to the current print job and narrow web 201 corresponds to the next print job. The current print job data is known via a file JDF1 and the next print job data is known via a file JDF2. Wide web 200 and narrow web 201 both travel in direction Z shown in FIG. 2.

Slitter 25, in the presently preferred embodiment, includes three slitter blades 25A, 25B and 25C and three associated actuators 33A, 33B and 33C. In this presently preferred embodiment, the three slitter blades 25A, 25B and 25C can be moved laterally via respective operably connected actuators 33A, 33B and 33C. The number of slitters 25 and actuators 33 is shown as three, but as one of skill in the art will readily recognize, could be greater or lesser, depending on the different job requirements for printing press 100.

In the example shown in FIG. 2, wide web 200 (the current job web) is 40 inches wide. X1, X2 and X3 represent the lateral positions of slitters 25A, 25B, 25C for the current printjob. Wide web 200 is slit into four different ten inch ribbons. For the present job in this example, slitter 25A is laterally positioned at the X1 position, which is 10 inches from an edge 202 of wide web 200, slitter 25B is laterally positioned at the X2 position, which is 20 inches from the edge 202 and slitter 25C is laterally positioned at the X3 position, which is 30 inches from the edge 202. The lateral positions of slitters 25A (X1), 25B (X2) and 25C (X3), the current print job data and the current printing press configuration are known to controller 11 via the JDF 1 file.

In the example shown in FIG. 2, narrow web 201 is 20 inches wide for the next print job and Y1, Y2 and Y3 represent the desired lateral positions of slitters 25A, 25B, 25C so that narrow web 201 will be slit into four different five inch ribbons. Thus, in this example, for the next print job, slitter 25A will be laterally positioned at the Y1 position, which is 5 inches from an edge 203 of narrow web 201 (15 inches from the edge 202), slitter 25B will be laterally positioned at the Y2 position, which is 10 inches from the edge 203 (20 inches from the edge 202) and slitter 25C will be laterally positioned at the Y3 position, which is 15 inches from the edge 203 (25 inches from the edge 202). The desired lateral positions of slitters 25A (Y1), 25B (Y2) and 25C (Y3), the new print job data and the new printing press configuration are known to controller 11 via the JDF2 file.

FIG. 2 shows that wide web 200 includes register marks 206 and 207 and that narrow web 201 includes register marks 208 and 209. Sensors 204, 205 detect the register marks 206, 207, respectfully, which indicate the beginning of a transition web distance D and provide controller 11 with a signal of the impending web change from wide web 200 to narrow web 201. Subsequently, upon detection of register marks 208, 209, sensors 204, 205 alert controller 11, for example, that the slitting of narrow web 201 according to the JDF2 file is currently taking place and/or that the end of transition web distance D has been reached.

In addition, sensors installed in splicer 13 can alert controller 11 of the splicing of narrow web 201 onto wide web 200. Such alert signal(s) may include, for example, splicing operation data such as the exact time and web speed at which the splicing operation took place. Also, sensors, strategically positioned throughout printing press 100, can notify controller 11 of the current location, within printing press 100, of the edge of narrow web 201 spliced onto wide web 200 and allow controller 11 to track the edge of narrow web 201 throughout printing press 100. Using splicing data, tracking data, JDF files and sensor data, controller 11 can calculate the exact time that narrow web 201 reaches various units within printing press 100 such as, for example, folder superstructure 26. Once that time is known, controller 11, using the sensor data and the JDF files, can calculate the new configuration information including the desired parameters, the timing for readjustment and the rate of readjustment of printing press 100 components such as, for example, slitters 25A, 25B, 25C, former board 29 and infeed rollers 30. When the desired parameters, the timing for readjustment and the rate of readjustment of slitters 25A, 25B, 25C, former board 29 and infeed rollers 30 are calculated, controller 11 issues commands to reconfigure printing press 100.

During printing, wide web 200 moves through printing press 100 at a designated transition velocity V, e.g., one meter per second (1 m/s). The transition velocity V is the maximum speed that is safe for lateral movement of slitters 25A, 25B, 25C without tearing the web or impairing the necessary web tension. The transition velocity V is known to controller 11 via the JDF file or sensor data. The transition velocity V may be different for different types of webs or different print jobs.

In operation, wide web 200 will reach a transition web distance D, e.g., two meters remaining from an end of an almost depleted wide web 200, at a particular point in time. The transition web distance D is the minimum amount of web, when it is traveling at a certain transition velocity V or a minimum setup speed, that is necessary for safe readjustment of slitters 25A, 25B, 25C and former board 29 without tearing the web or impairing the necessary web tension. The amount of transition web distance D is calculated by controller 11 via the JDF file or sensor data. The transition web distance D may be different for different types of webs or different print jobs.

Since the transition web distance D, the transition velocity V, the current position (X1, X2, X3) and desired position (Y1, Y2, Y3) of slitters 25A, 25B, 25C and the print job data and the printing press configuration data for both print jobs are known to controller 11, in operation, controller 11 calculates a transitioning time T and the rate of lateral movement for slitters 25A, 25B, 25C. Once the transitioning time T and the rate of lateral movement for slitters 25A, 25B, 25C are known and the transition web distance D is detected by sensors 204, 205, controller 11 begins to laterally reposition slitters 25A, 25B, 25C for slitting of narrow web 201 from the X1, X2, X3 positions to the Y1, Y2, Y3 positions as disclosed in the JDF2 file.

Three scenarios are possible for transition. First, it is possible that when the web reaches the end of the transition web distance D, slitters 25A, 25B, 25C will have completed their lateral repositioning movement from the X1, X2, X3 positions to the Y1, Y2, Y3 positions. Second, it is possible that slitters 25A, 25B, 25C, located at the positions X1, X2, X3, may not completely reposition to the Y1, Y2, Y3 positions by the time the web reaches the end of transition web distance D, but instead will reach the Y1, Y2, Y3 positions after the transition to narrow web 201. This is possible if the lateral positions of slitters 25A, 25B, 25C are within the width of narrow web 201 at the time when the transition to narrow web 201 reaches slitters 25A, 25B, 25C. In this scenario, the transition time may be extended. Third, it is possible that slitters 25A, 25B, 25C, located at the positions X1, X2, X3, may reach the Y1, Y2, Y3 positions before narrow web 201 reaches slitters 25A, 25B, 25C. In this scenario, the transition time is shortened.

In order to minimize web waste and optimize printing press efficiency, controller 11 will use sensor and the JDF files to determine the optimal method of readjusting slitters 25A, 25B, 25C (before, at or after slitters 25A, 25B, 25C reach the end of transition web distance D) and execute the slitter adjustment accordingly.

In one embodiment, controller 11 uses the formula: T=D/V to calculate the transition time T that it would take for narrow web 201 to travel the transition web distance D at a given transition velocity V. For example, when the transition web distance D is 2 meters and the transition velocity V is 1 meters/second, it will take 2 seconds for wide web 200 to travel the transition web distance D.

The lateral distance LD, which is the amount of lateral movement that each individual slitter of slitters 25 will move from the current positions (X1, X2, X3) to the new desired lateral positions (Y1, Y2, Y3), is also be known to controller 11. In the FIG. 2 example, the lateral distance LD for slitter 25A is five inches, the lateral distance LD for slitter 25B is zero inches and the lateral position LD for slitter 25C is five inches.

In the FIG. 2 example, since the transition velocity V is 1 m/s, the lateral distance LD is five inches for slitters 25A, 25C, the transition time T is two seconds and the transition web distance D is two meters, slitters 25A, 25C will laterally move from the positions X1, X3 to the positions Y1, Y3 at the rate of 2.5 inches per second of travel along the transition distance D. The cut-curve path traveled by slitters 25A, 25C through this transition will resemble an inward parabolic curve.

The maximum lateral speed of slitters 25A, 25B, 25C will be obtained via known data such as, for example, JDF data for a given web type.

The newly introduced narrow web 201 is advanced through printing press 100 by the preceding wide web 200, which pulls the narrow web 201 as wide web 200 travels through printing press 100.

Reconfiguration of printing press 100, from wide web 200 to narrow web 201, will be accomplished if no ribbon path changes are needed. The ribbon path will be known to printing press 100 via at least one of the JDF files.

FIG. 3 schematically shows an example of an automatic slitter adjustment for a print job transfer from a narrow web 300 to a wide web 301. The current print job data is known via the JDF1 file and the next print job data is known via the JDF2 file. Narrow web 300 and wide web 301 are both traveling in direction Z.

In the example shown in FIG. 3, narrow web 300 (the current job web) is 20 inches wide and X1, X2, X3 represent the current lateral positions of slitters 25A, 25B, 25C for the current print job, which slit narrow web 300 into four different five inch ribbons. For the present job, the X1 position is 5 inches from an edge 302 of narrow web 300, the X2 position is 10 inches from the edge 302 and the X3 position is 15 inches from the edge 302. The lateral positions of slitters 25A (X1), 25B (X2) and 25C (X3), the current print job data and the current printing press configuration are known to controller 11 via the JDF1 file.

In the example shown in FIG. 3, for the next print job, wide web 301 is 40 inches wide and Y1, Y2 and Y3 represent the desired lateral positions of slitters 25A, 25B, 25C for the next print job so that wide web 301 will be slit into four different ten inch ribbons. Thus, the Y1 position is 10 inches from an edge 303 of wide web 301, the Y2 position is 20 inches from the edge 303 and the Y3 position is 30 inches from the edge 303. The desired lateral positions of slitters 25A (Y1), 25B (Y2), 25C (Y3), the new print job data and the new printing press configuration are known to controller 11 via the JDF2 file.

FIG. 3 shows register marks 312 and 313 on narrow web 300 and register marks 314 and 315 on wide web 301. Sensors 306, 307 detect register marks 312, 313, respectfully, which indicate the beginning of the transition web distance D and provide controller 11 with a signal of the impending web change from narrow web 300 to wide web 301. Upon detection of register marks 314, 315, sensors 306, 307 alert controller 11, for example, that slitting of wide web 301 according to the JDF2 file is currently taking place and/or that the end of a ramp-cut has been reached and/or that the end of transition web distance D has been reached.

In addition, sensors installed in splicer 13 can alert controller 11 of the splicing of wide web 301 onto narrow web 300. Unlike the exemplary slitter adjustment in FIG. 2, the switch from narrow web 300 to wide web 301 necessitates a ramp-cut, via splicer 13, on wide web 301 as wide web 301 is pulled through printing press 100 by narrow web 300. Areas cut from wide web 301 are designated by reference numbers 304 and 305.

Upon splicing of wide web 301 onto narrow web 300, sensors installed in splicer 13 can alert controller 11 of the splicing of wide web 301 onto narrow web 300. Such alert signal(s) may include such as, for example, the ramp-cut details, the exact time and the web speed at which the splicing operation took place.

Also, sensors, strategically positioned throughout printing press 100, can notify controller 11 of the current location, within printing press 100, of the edge of wide web 301 spliced onto narrow web 300 and allow controller 11 to track the edge of wide web 301 throughout printing press 100. Using splicing data, tracking data, JDF files and sensor data, controller 11 can calculate the exact time that wide web 301 reaches various units within printing press 100 such as, for example, folder superstructure 26. Once that time is known, controller 11, using the sensor data and the JDF files, can calculate the new configuration information including the desired parameters, the timing for readjustment and the rate of readjustment of printing press 100 components such as, for example, slitters 25A, 25B, 25C, former board 29 and infeed rollers 30. When the desired parameters, the timing for readjustment and the rate of readjustment of slitters 25A, 25B, 25C, former board 29 and infeed rollers 30 are calculated, controller 11 issues a command to reconfigure printing press 100.

During printing, narrow web 300 moves through printing press 100 at a transition velocity V, e.g., one meter per second (1 m/s) and reaches the transition web distance D of two meters remaining from an end of an almost depleted narrow web 300 at a particular point in time. The transition web distance D, the transition velocity V, the current position (X1, X2, X3) and the desired position (Y1, Y2, Y3) of slitters 25A, 25B, 25C and the print job data and the printing press configuration data for both jobs are known to controller 11. Thus, controller 11 calculates the transitioning time T and the rate of lateral movement for slitters 25A, 25B, 25C. Once the transitioning time T and the rate of lateral movement for slitters 25A, 25B, 25C are known and the transition web distance D is detected by sensors 306, 307, controller 11, if necessary, begins to laterally reposition slitters 25A, 25B, 25C, for slitting wide web 301, from the X1, X2, X3 positions to the Y1, Y2, Y3 positions as disclosed in JDF2 file.

The same three scenarios exist with respect to the transition of the slitters, except that if any of the slitters need to be positioned to a point outside the dimension of the current web, the transition will never take less than time T.

The FIG. 3 example, like the FIG. 2 example, will take 2 seconds for narrow web 300 to travel the transition web distance D, based on the same simple formula. The lateral distance LD for slitter 25A is five inches, the lateral distance LD for slitter 25B is zero inches and the lateral distance LD for slitter 25C is five inches.

As with the FIG. 2 example, slitters 25A, 25C will laterally move at the rate of 2.5 inches per second of travel along the transition distance D. The cut-curve path traveled by slitters 25A, 25B will resemble an outwards parabolic curve.

While the present invention has been particularly shown and described with reference to the preferred embodiments and various aspects thereof, it will be appreciated by those of ordinary skill in the art that various changes and modifications may be made without departing from the spirit and scope of the invention. It is intended that the appended claims be interpreted as including the embodiments described herein, the alternatives mentioned above, and all equivalents thereto.

What is claimed is:

1. A method for automatically controlling a printing press including at least one reconfigurable printing mechanism, comprising the steps of;
configuring the at least one reconfigurable printing mechanism to print according to a first set of predetermined printing parameters for a first print job;
printing the first print job on a first print web;
detecting the completion of the first print job and automatically configuring the at least one reconfigurable printing mechanism to print according to a second set of predetermined printing parameters different from the first set of predetermined printing parameters for a second print job; and
printing the second print job on a second print web.

2. The method of claim 1, wherein the first print web is the same size as the second print web.

3. The method of claim 1, wherein the first print web is a different size as the second print web.

4. The method of claim 1, wherein at least one of the printing mechanisms is a slitter which can be automatically reconfigured to slit the web at different positions.

5. The method of claim 4, wherein the step of automatically configuring the printing mechanism is performed by laterally moving at least one slitter blades in the slitter.

6. The method of claim 5, wherein the lateral movement of the one or more slitter blades in the slitter is performed by separate actuators associated with each slitter blade.

7. The method of claim 1, wherein the step of detecting the completion of the first print job is performed by a sensor which senses predetermined register marks on the first print web.

8. A web fed rotary printing press comprising:
at least one printing mechanism which is reconfigurable based on received control signals;
a sensor for detecting the end of a print job; and
a controller coupled to the sensor and the at least one printing mechanism and which provides control signals representing predetermined printing parameters for a subsequent print job to the at least one print mechanism upon detection of the end of a print job.

9. The web fed rotary printing press of claim 8, further comprising:
a planning computer coupled to the controller for generating printing parameters for each print job based on user input.

10. The web fed rotary printing press of claim 9, wherein the printing parameters generated by the planning computer for a print job are stored as data in JDF files communicated to the controller and wherein the controller provides control signals representing predetermined printing parameters for a print job based on the data in the JDF files.

11. The web fed rotary printing press of claim 8, wherein the controller also generates printing parameters for each print job based on user input.

12. The web fed rotary printing press of claim 11, wherein the printing parameters generated by the controller are stored as data in JDF files and the controller provides control signals representing predetermined printing parameters for a print job based on the data in the JDF files.

13. The web fed rotary printing press of claim 8, wherein at least one of the printing mechanisms is a slitter which can be automatically reconfigured to slit the web at different positions.

14. The web fed rotary printing press of claim 13, wherein the slitter comprises at least one slitter blade capable of lateral movement during configuration.

15. The web fed rotary printing press of claim 14, wherein the slitter comprises an actuator associated with each slitter blade for moving the associated slitter blade laterally.

16. The web fed rotary printing press of claim 8, wherein the sensor detects the completion of a print job by sensing predetermined register marks on the print web.
